(19) United States
(12) Patent Application Publication
(10) Pub. No.: US 2009/0089788 A1
(43) Pub. Date: Apr. 2, 2009

(54) SYSTEM AND METHOD FOR HANDLING RESOURCE CONTENTION

(75) Inventor: Rodney Fredrick Turner, Duncraig (AU)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/864,662

(22) Filed: Sep. 28, 2007

(51) Int. Cl. G06F 9/46

(52) U.S. Cl. 718/104

(57) ABSTRACT

In one aspect, the invention is directed to a method by which a user of a functional resource in a software environment can determine whether any other users are waiting to acquire control of the functional resource. The functional resource has associated therewith, a placeholder resource that is a placeholder for users waiting to acquire control of the functional resource. The method includes inquiring by the user of the functional resource whether the placeholder resource is available for exclusive control by the user of the functional resource. If the placeholder resource is available for exclusive control, then no other users are waiting for control of the functional resource and so the current user can keep control of it. If, however, the placeholder resource is not available, that indicates to the user of the functional resource that at least one other user is waiting for control of the functional resource and so the user of the functional resource may release control of the functional resource.

### FIELD OF THE INVENTION

The invention relates to the field of handling resource contention in a software environment such as a systems complex or a single system.

### BACKGROUND OF THE INVENTION

In information handling systems, it is common for multiple users to require access to common resources. When multiple users require mutually exclusive access to a particular resource at the same time, a condition known as resource contention exists. Typically, a queue is formed of users who wait for access to the resource while it is occupied by one or more users.

An example situation illustrating resource contention is shown in FIG. 1. A user, shown at 400, may have multiple actions to perform on a resource 402 over some period of time. For efficiency, the user 400 might acquire control of the resource 402 and may maintain control of the resource 402 until all of the required actions involving the resource 402 are completed. In the example shown in FIG. 1a, the control acquired by the user 400 over the resource 402 is exclusive control, which is distinguished from shared control. Exclusive control means that no other user is permitted to have access to the resource 402 while it is under the control of the user 400. While the user 400 has control of the resource 402, other users, shown at 404, 406 and 408 request some kind of control (ie. either exclusive or shared control) of the resource 402.

In between actions by the user 400, however, there may be periods in which the resource 402 could be released by the user 400 with little negative impact on the user 400, but which would have significant benefit to some or all of the other users 404, 406 and 408 waiting for the resource 402. During such periods the user 400 may wish to find out if there are other users, such as the users 404, 406 and 408 waiting for the resource 402, to know whether to release the resource 402.

Currently, however, in some environments, such as an MVS™ environment, there is no simple way for the user 400 of the resource 402 to tell whether other users, such as the users 404, 406 or 408, are waiting to acquire control of the resource 402. In general, a user, such as any of the users 400, 404, 406 and 408 can perform an enquiry to determine whether a particular resource, such as the resource 402 is in use. They cannot, however, easily gain information on whether a queue is present behind the actual user 400.

There is, in general, a continuing need for improved ways for the handling resource contention in an efficient manner.

### SUMMARY OF THE INVENTION

In a first aspect, the invention is directed to a method by which a user of a functional resource in a software environment can determine whether any other users are waiting to acquire control of the functional resource. The functional resource has associated therewith, a placeholder resource that is a placeholder for users waiting to acquire control of the functional resource. The method includes inquiring by the user of the functional resource whether the placeholder resource is available for exclusive control by the user of the functional resource. If the placeholder resource is available for exclusive control, then no other users are waiting for control of the functional resource and so the current user can keep control of it. If, however, the placeholder resource is not available, that indicates to the user of the functional resource that at least one other user is waiting for control of the functional resource and so the user of the functional resource may release control of the functional resource.

In a second aspect, the invention is directed to a method for managing contention among at least first and second users for control of a functional resource in a software environment, comprising:

a) acquiring control of the functional resource by the first user;
b) acquiring control of a placeholder resource by the second user after step a);
c) inquiring whether the placeholder resource is available for exclusive control by the first user;
d) releasing control of the functional resource by the first user if the placeholder resource is not available;
e) acquiring control of the functional resource by the second user; and
f) release of the placeholder resource by the second user.

In a third aspect, the invention is directed to a software environment that provides the capability for a first user to determine if any other user is waiting to acquire control of a functional resource, comprising:

A placeholder resource that is associated with the functional resource;

Executable code that provides for the acquisition of control of the placeholder resource by said any other user; and

Executable code that indicates to the first user whether the placeholder resource is available.

In a fourth aspect, the invention is directed to a data processing system, comprising:

at least one processor;

a bus coupled to the at least one processor;

at least one computer usable medium coupled to the bus, wherein the at least one computer usable medium contains a functional resource and a placeholder resource associated with the functional resource, wherein the at least one computer usable medium contains:

a first set of instructions that are executable by the at least one processor for acquiring control of the placeholder resource by a user waiting to acquire control of the functional resource; and

a second set of instructions that are executable by the at least one processor for indicating to another user whether the placeholder resource is available for exclusive control to the other user.

In a fifth aspect, the invention is directed to a computer program product for use in a software environment including a functional resource and a placeholder resource that is associated with the functional resource and that serves as a placeholder for a user waiting to acquire control of the functional resource, wherein the computer program product comprises at least one computer usable medium including:

computer-usable program code for acquiring control of the placeholder resource by a user waiting to acquire control of the functional resource; and

computer-usable program for indicating to another user whether the placeholder resource is available for exclusive control to the other user.

### BRIEF DESCRIPTION OF THE DRAWINGS

For a better understanding of the present invention, and to show more clearly how it may be carried into effect, reference will now be made, by way of example, to the accompanying drawings in which:

FIG. 1 is an illustration of a resource contention in accordance with the prior art;

FIG. 2 is a pictorial representation of a data processing system in which aspects of the present invention may be implemented;

FIG. 3 is a block diagram of a data processing system in which aspects of the present invention may be implemented;

FIG. 4 is a schematic diagram of a systems complex in accordance with a first aspect of the invention;

FIGS. 5a-5l are illustrations of stages of handling a resource contention on the systems complex shown in FIG. 4 to illustrate the handling of the resource contention in accordance with an embodiment of the present invention;

FIGS. 6a-6f are illustrations of stages of handling another type of resource contention; and

FIG. 7a-7h are illustrations of stages of handling yet another type of resource contention, in accordance with another embodiment of the present invention.

### DETAILED DESCRIPTION OF THE INVENTION

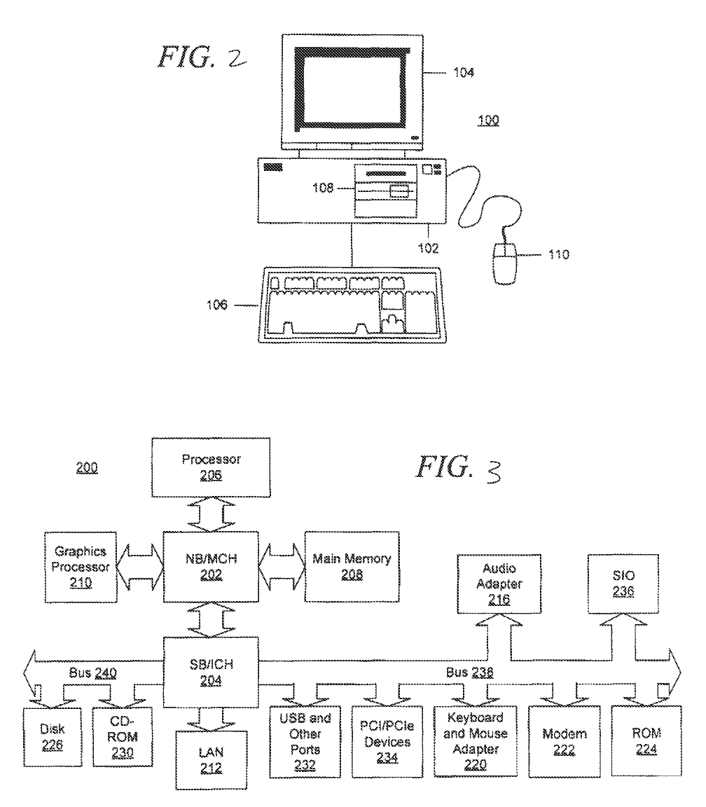

FIG. 2 is a pictorial representation of a data processing system in which aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 may be implemented using any suitable computer, such as an IBM® eServer™ computer or IntelliStation® computer, which are products of International Business Machines Corporation, located in Armonk, N.Y. Although the depicted representation shows a personal computer, exemplary aspects of the present invention may be implemented in other types of data processing systems, such as laptop computers, palmtop computers, handheld computers, network computers, servers, workstations, cellular telephones and similar wireless devices, personal digital assistants and other electronic devices on which software programs may be installed. Computer 100 also preferably includes a graphical user interface (GUI) that may be implemented by means of systems software residing in computer readable media in operation within computer 100.

With reference now to FIG. 3, a block diagram of a data processing system is shown in which aspects of the present invention may be implemented. Data processing system 200 is an example of a computer, such as personal computer 100 in FIG. 2, in which code or instructions implementing the processes of the exemplary aspects may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH 202 through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 424, universal serial bus (USB) ports and other communications ports 232, and PCI/PCIe devices 234 connect to south bridge and I/O controller hub 204 through bus 238. Hard disk drive (HDD) 226 and CD-ROM drive 230 connect to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter.

An operating system runs on processor 206 and coordinates and provides control of various components within data processing system 200 in FIG. 3. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. (Java and all Java-based trademarks are trademarks of Sun Microsystems, Inc. in the United States, other countries, or both.)

Instructions for the operating system, the object-oriented programming system, and applications or programs are located on storage devices, such as hard disk drive 226, and may be loaded into main memory 208 for execution by processor 206. Aspects of the present invention may be performed by processor 206 using computer implemented instructions, which may be located in a memory such as, for example, main memory 208, read only memory 224, or in one or more peripheral devices.

Those of ordinary skill in the art will appreciate that the hardware in FIGS. 2-3 may vary depending on the implementation. Other internal hardware or peripheral devices, such as flash memory, equivalent non-volatile memory, or optical disk drives and the like, may be used in addition to or in place of the hardware depicted in FIGS. 2-3. Also, the processes of the present invention may be applied to a multiprocessor data processing system.

In some illustrative examples, data processing system 200 may be a personal digital assistant (PDA), which may be configured with flash memory to provide non-volatile memory for storing operating system files and/or user-generated data. A memory may be, for example, main memory 208 or a cache such as found in north bridge and memory controller hub 202. A processing unit may include one or more processors. The depicted examples in FIGS. 2-3 and above-described examples are not meant to imply architectural limitations. For example, data processing system 200 also may be a tablet computer, laptop computer, or telephone device in addition to taking the form of a PDA.

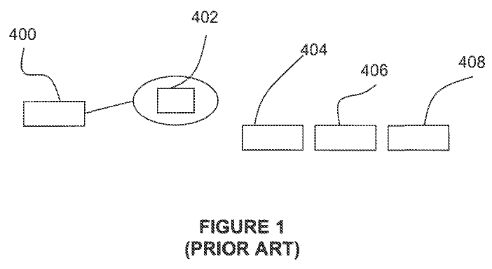

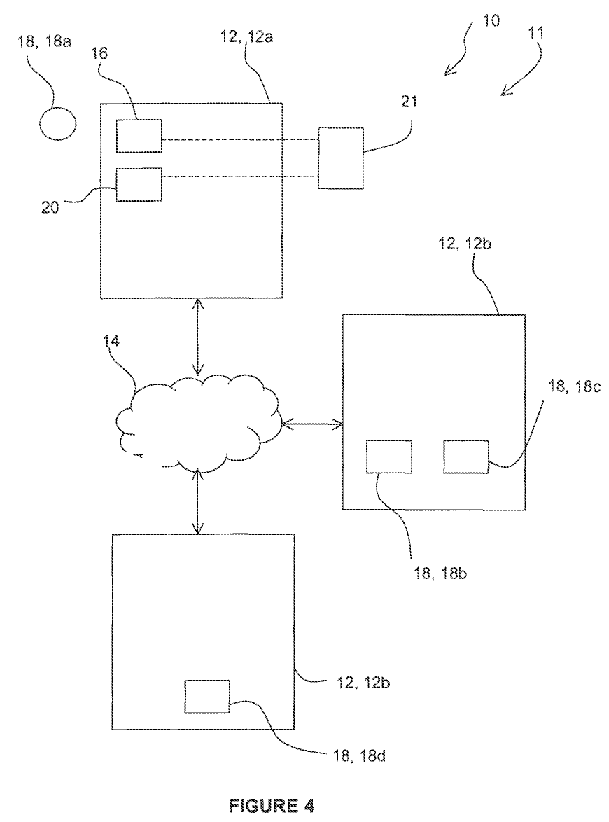

Reference is made to FIG. 4, which shows a particular example of a software environment 10 in accordance with an embodiment of the present invention. The software environment 10 shown in FIG. 1 is a systems complex 11 that includes a plurality of systems 12, which are identified individually at 12a, 12b and 12c, and which are all connected together by an interconnection 14, which may be any suitable type of connection known in the art. Three systems 12 are shown, however, it will be understood that there could be as few as two systems in the systems complex 11, or alternatively many more systems 12 in the systems complex 11. Many items that make up part of the systems complex 11 are not shown for clarity.

The systems 12 in the systems complex 11 may be present on individual physical machines (ie. computers). Alternatively, the systems 12 may be partitioned spaces on a single machine. The systems complex 11 may include one or more machines that are partitioned each with multiple systems 12 thereon and one or more individual machines each with a single system 12 thereon.

A resource 16 is present on the system 12a. The resource 16 may be any suitable type of resource, such as, for example, a database or an activity log, and is generally speaking, an application or file that is used by one or more users to achieve some function. The resource 16 may be referred to as a functional resource 16 so as to highlight that it is called upon to serve a specific function. There may be as few as one functional resource in the systems complex 11 or alternatively, there may be many more functional resources 16 in the systems complex 11.

A plurality of users 18 are shown in the systems complex 11. The users 18 may be distributed across any number of systems 12 in the systems complex 11, and are shown individually at 18a, 18b, 18c and 18d. It will be understood that the actual number of users 18 may vary and may be as few as one, or may be many more than the four users 18 shown in FIG. 4. The users 18 use the resources 16 for a variety of purposes. The users 18 may be people, as shown at 18a, or alternatively, may be software or the like on a machine, as shown at 18b, 18c and 18d.

For each resource 16 there is provided a placeholder resource, which is shown at 20. The placeholder resource 20 may be non-functional and may simply be a dummy resource (eg. an empty file), or alternatively it may serve some function. The purpose of the placeholder resource 20 is explained further below.

A resource manager 21 is provided that controls access to resources, such as the functional resource 16 and the placeholder resource 20 in the systems complex 11. The resource manager 21 may manage a queue of users 18 waiting for control of a particular resource.

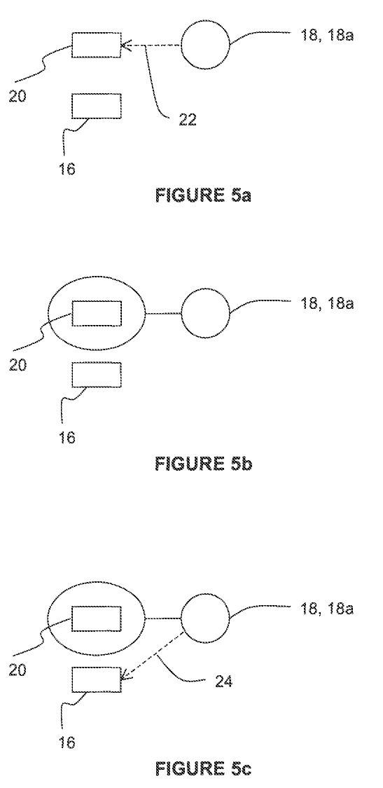

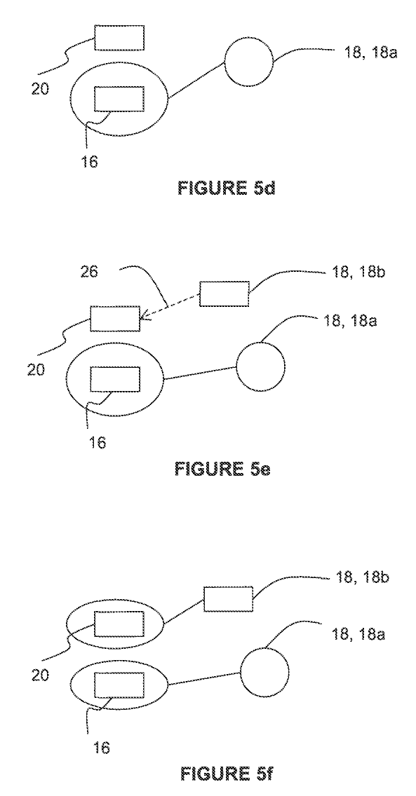

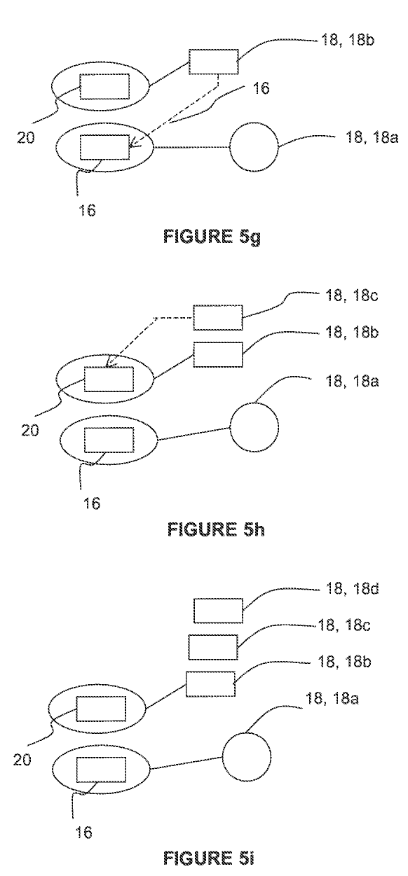

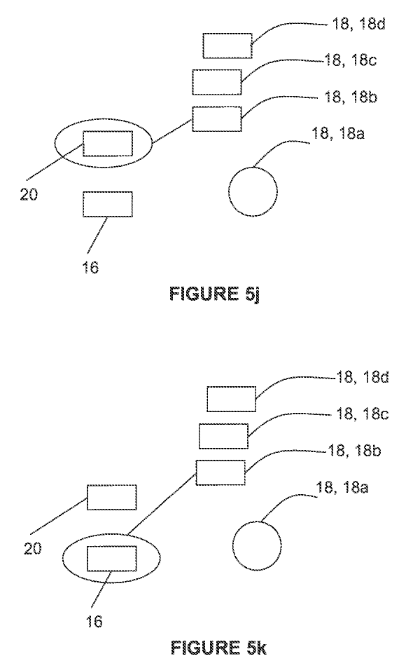

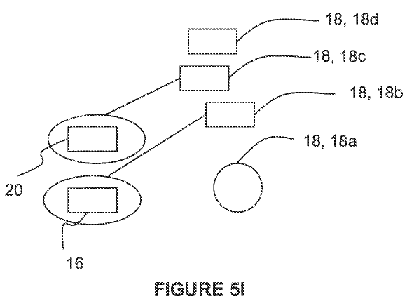

Referring to FIG. 5a-5l, the build-up of a resource contention and the subsequent handling of the resource contention are illustrated. Referring to FIG. 5a, the first user 18a may require exclusive control of the functional resource 16. To acquire control of the functional resource 16, the first user 18a first requests exclusive control of the placeholder resource 20, as illustrated by the dashed pointer line 22. The placeholder resource 20 is available, and so the first user 18a is given exclusive control of the placeholder resource 20, as shown in FIG. 5b. At that point, the first user 18a requests exclusive control of the functional resource 16, as shown by the dashed pointer line 24 in FIG. 5c. The functional resource 16 is available and so the first user 18a acquires exclusive control of the functional resource 16, and releases control of the placeholder resource 20, as shown in FIG. 5d.

A second user 18b, may request exclusive control of the placeholder resource 20 as shown by the dashed pointer line 26 in FIG. 5e. The placeholder resource 20 is available and so the second user 18b acquires exclusive control of the placeholder resource 20, as shown in FIG. 5f. The second user 18b then requests exclusive control of the functional resource 16, as shown by the dashed pointer line 28 in FIG. 5g. The functional resource 16 is unavailable, however, and so the request fails. The second user 18b maintains control of the placeholder resource 20.

A third user 18c later requests exclusive control of the placeholder resource 20, as shown by the dashed pointer line 30 in FIG. 5h. The placeholder resource 20 is unavailable, however, and so the request fails. The third user 18c may be held in a queue for the placeholder resource 20. A fourth user 18d may similarly request exclusive control over the placeholder resource 20, which is unavailable, and so the fourth user 18d may be placed in the queue behind the third user 18c, see FIG. 5i.

At a suitable moment while the first user 18a has exclusive control of the functional resource 16, the first user 18a may conduct an enquiry of whether the placeholder resource 20 is available for exclusive control. Note that the enquiry relates to exclusive control of the placeholder resource 20 regardless of the type of control possessed by the first user 18a on the functional resource 16. If the placeholder resource 20 is available, as shown, for example, in FIG. 5b, then that indicates to the first user 18a that no other users 18 are waiting for the functional resource 16, and so there is no need for the first user 18a to release control of the functional resource 16. If, however, the placeholder resource 20 is not available, as shown in FIG. 5i, then that indicates to the first user 18a that there is a user (which in this case is the second user 18b) waiting for the functional resource 16, and so the first user 18a may release control of the functional resource 16 if it makes sense from the perspectives of time efficiency and overall need.

Thus, the first user 18a is easily provided with information regarding whether there are other users 18 waiting for the functional resource 16 that is controlled by the first user 18a.

At some point, the first user 18a releases control of the functional resource 16, as shown in FIG. 5j. For example, as noted above, the first user 18a may release control of the functional resource 16 upon receiving an indication that the placeholder resource 20 is unavailable. Upon the release of the functional resource 16, the resource manager 21 for the systems complex 11 may provide the second user 18b with control of the functional resource 16, and control of the placeholder resource 20 may be released by the second user 18b, as shown in FIG. 5k. At that point, the resource manager 21 may provide control of the placeholder resource 20 to the third user 18c, as shown in FIG. 51.

By permitting a user that is controlling a resource with a simple way of checking whether there are any other users waiting for that resource, permits the resource to be used more efficiently, rather than tying up the resource unnecessarily.

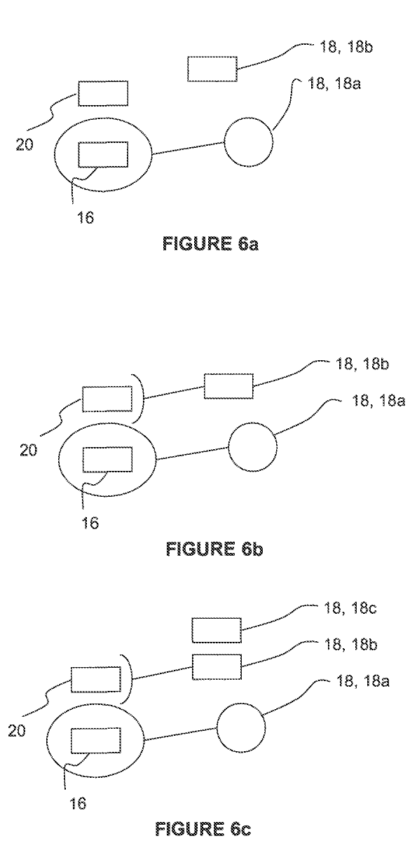

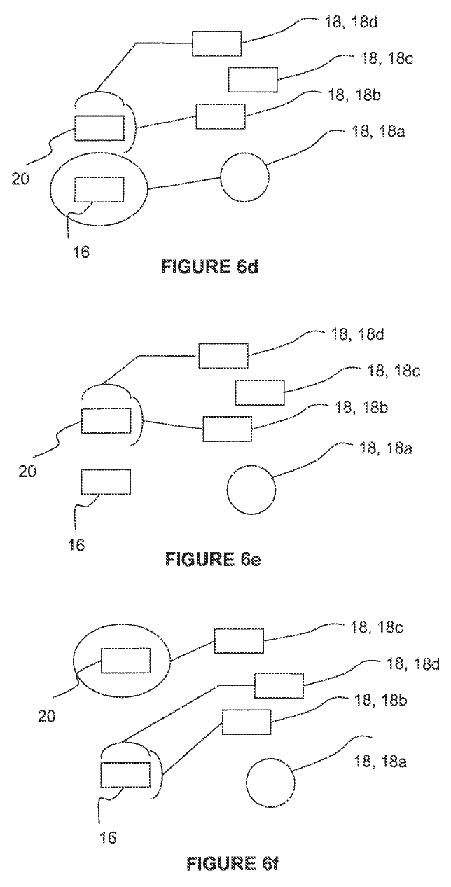

Reference is made to FIG. 6a-6f, which illustrate a situation wherein the first user 18a has exclusive control of a functional resource 16 and a second user 18b requires shared control of the functional resource 16 (FIG. 6a).

In such a case, the second resource 18b requests shared control of the placeholder resource 20. The placeholder resource 20 is available and so the second user 18b acquires shared control of the placeholder resource 20 (FIG. 6b), however the first user 18a exclusively controls the functional resource 16, and so the second user 18b remains having shared control of the placeholder resource 20.

A third user 18c (FIG. 6c) requests exclusive control of the placeholder resource 20. Since the placeholder resource 20 is under shared control by the second user 18b, the request fails. The third user 18c is placed in the queue for users 18 waiting for control of the placeholder resource 20.

A fourth user 18d (FIG. 6d) requests shared control of the placeholder resource 20. Since the placeholder resource 20 is available for shared control, the fourth user 18d is provided with shared control, alongside the second user 18b, while the third user 18c remains in the queue. The fourth user requests control of the functional resource 16, however, the functional resource 16 is being held by the first user 18a, and so the fourth user remains in control of the placeholder resource 20.

At some point, the first user 18a may conduct an enquiry as to whether the placeholder resource 20 is available for exclusive control. An indication is sent to the first user 18a that the placeholder resource 20 is being held (ie. by the second and fourth users 18b and 18d). As a result, the first user 18a may release control of the functional resource 16 (FIG. 6e).

The resource manager 21 may then provide the second and fourth users 18b and 18d with shared control of the functional resource 16. Control of the placeholder resource 20 is released by the second and fourth users 18b and 18d so that the next user, ie. the third user 18c, can acquire control of the placeholder resource 20 (FIG. 6f).

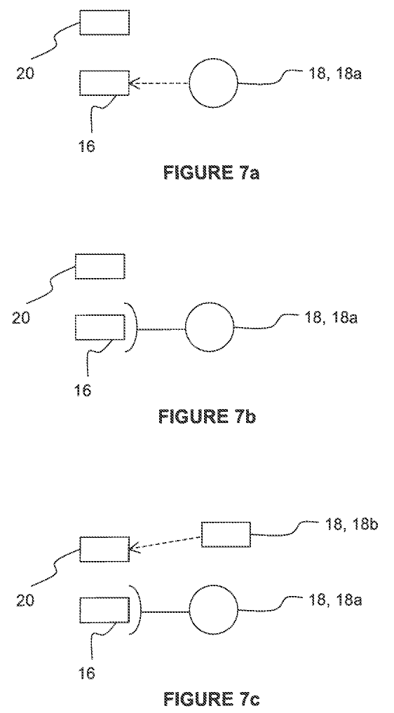

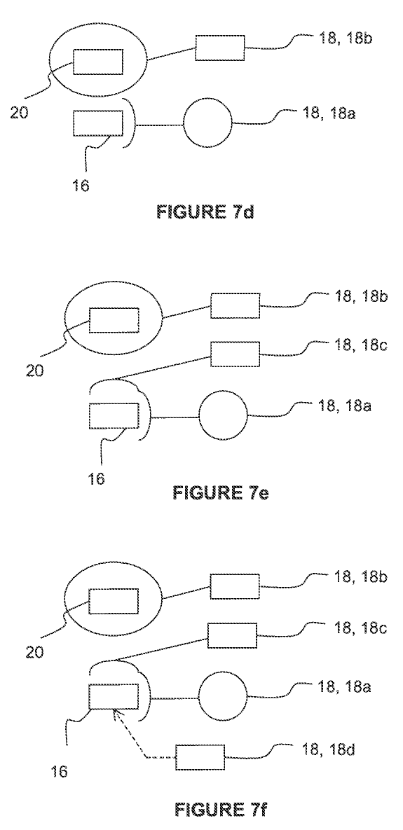

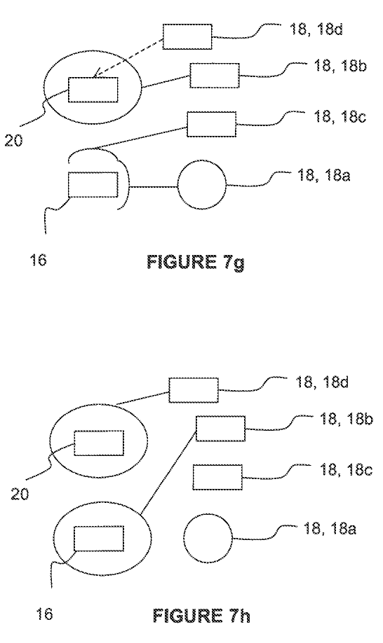

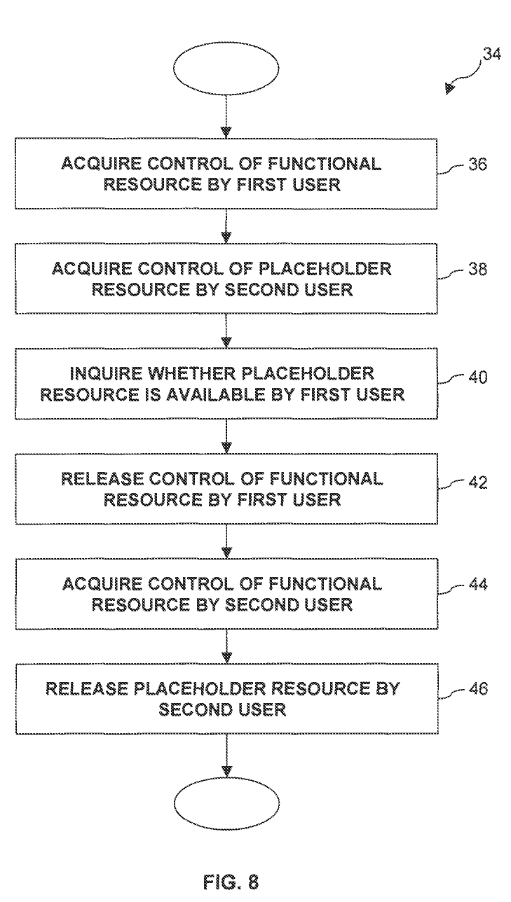

Reference is made to FIGS. 7a-7h, which illustrate another type of resource contention and another method of handling the contention. Shown in FIG. 7a is a functional resource 16 and a placeholder resource 20. The first user 18a may require control of the functional resource 16. In this method, the first user 18a requests control directly of the functional resource 16. In this particular example, the first user 18a requests shared control of the functional resource 16. The functional resource 16 is available and so the first user 18a acquires control of the functional resource 16 (FIG. 7b).

A second user 18b requests exclusive control directly of the functional resource 16 (FIG. 7c) and the request fails, since the functional resource is held by the first user 18a. After receiving an indication of the failed request, the second user 18b requests and acquires exclusive control of the placeholder resource 20 (FIG. 7d) and waits for the functional resource 16 to become available.

A third user 18c requests shared control directly of the functional resource 16 (FIG. 7e) and is provided with such shared control alongside the first user 18a.

A fourth user 18d requests exclusive control directly of the functional resource 16 (FIG. 7f) and the request fails, since the functional resource 16 is held by the first and third users 18a and 18c. The fourth user 18d subsequently requests exclusive control directly of the placeholder resource 20 (FIG. 7g) and the request fails, since the placeholder resource 20 is held by the second user 18b. As a result, the fourth user 18d is place in a queue for the placeholder resource 20.

At some point, one of the first and third users 18a and 18c, such as for example, the first user 18a, may perform an enquiry to see whether the placeholder resource 20 is available for exclusive control and receives an indication that the placeholder resource 20 is not available. After receiving that indication, the enquirer (in this case, the first user 18a), may release control of the resource 16. Additionally, the other user in control of the functional resource 16, namely the third user 18c, may also perform an enquiry regarding the availability of the placeholder resource 20 for exclusive control and may also release control of the functional resource 16. If control of the functional resource 16 is released by all users 18 in control of it, namely the first and third users 18a and 18c, the second user 18b that is in control of the placeholder resource 20 may be provided with control of the functional resource 16 and may release control of the placeholder resource 20. At that point, the fourth user 18d would be provided with control of the placeholder resource 20, as seen in FIG. 7h.

Thus, the method illustrated in FIGS. 7a-7h entails requesting control of the functional resource first and upon failure of that, requesting control of the placeholder resource. This permits users 18 who request shared control of the functional resource 16 to gain access to the functional resource 16 even in a situation when another user 18 has exclusive control of the placeholder resource 20.

It has been shown above for the users 18 and the functional and placeholder resources 16 and 20 to be in a software environment that included a systems complex 11. It will be apparent that the invention described herein is also applicable to other types of software environment, such as, for example, a software environment that includes a single system 12 and not a complex of systems.

It has been shown in FIG. 4, for the first user 18a to be a person and for the other users 18b, 18c and 18d to be applications. It will be understood that any of the users, may be from a person and any of the users may be applications (ie. programming code, such as software or firmware).

Methods have been described herein implicitly, which may be clarified by way of flow diagrams, such as that which is shown in FIG. 8, which illustrates a method 34 for managing contention among at least first and second users for control of a functional resource in a software environment. The method 34 includes a step 36, which entails acquiring control of the functional resource 16 (FIG. 5d) by the first user 18a; a step 38, which entails acquiring control of the placeholder resource 20 (FIG. 5f) by the second user 18b; a step 40, which entails inquiring whether the placeholder resource 20 (FIG. 5f) is available for exclusive control by the first user 18a; a step 42 of releasing control of the functional resource 16 (FIG. 5j) by the first user 18a if the placeholder resource 20 is not available; a step 44 of acquiring control of the functional resource 16 (FIG. 5k) by the second user 18b; and a step 46 of releasing the placeholder resource 20 by the second user 18b.

The method 34 may entail the users 18 attempting to acquire control of the placeholder resource 20 before attempting to acquire control of the functional resource 16. Alternatively, the method 34 may entail the users 18 attempting to acquire control of the functional resource 16 before attempting to acquire control of the placeholder resource 20.

It is possible for the above-described methods to be carried out manually. It is also possible for the methods described herein to be carried out by automated means, such as by software. It is also possible for the methods described herein to be carried out by a combination of manual and automated means. It is possible for the above-described method to be carried out using a computer program product comprising at least one computer usable medium including computer-usable program code. It is possible to provide a data processing system comprising at least one processor, a bus coupled to the at least one processor, and at least one computer usable medium coupled to the bus, wherein the at least one computer usable medium contains a set of instructions and wherein the at least one processor is adapted to carry out the set of instructions by causing the data processing system to carry out any of the above described methods.

In embodiments wherein one or more steps of the methods described herein are carried out using software, the coding of the software is within the skill of a person skilled in the art, after having read the description contained herein.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I/We claim:

1. A method for managing contention among at least first and second users for control of a functional resource in a software environment, comprising:
a) acquiring control of the functional resource by the first user;
b) acquiring control of a placeholder resource by the second user after step a);
c) inquiring whether the placeholder resource is available for exclusive control by the first user;
d) releasing control of the functional resource by the first user if the placeholder resource is not available;
e) acquiring control of the functional resource by the second user; and
f) release of the placeholder resource by the second user.

2. A method as claimed in claim 1, wherein, prior to step a), the method further comprises:
g) requesting control of the placeholder resource by the first user; and
h) acquiring control of the placeholder resource by the first user, and prior to step b), the method further comprises
i) releasing control of the placeholder resource by the first user.

3. A method as claimed in claim 1, wherein, prior to step b), the method further comprises:
j) requesting control of the functional resource by the second user;
k) requesting control of the placeholder resource by the second user if the functional resource is unavailable.

4. A method as claimed in claim 1, wherein at step b), the second user acquires shared control of the placeholder resource, and wherein at step e), the second user acquires shared control of the functional resource by the second user.

5. A method as claimed in claim 1, wherein the first and second users are software applications.

6. A method as claimed in claim 1, wherein at least one of the first and second users is a person.

7. A method for use by a user of a functional resource in a software environment, for determining whether any other users are waiting to acquire control of the functional resource, the method comprising:
inquiring by the user of the functional resource whether a placeholder resource is available for exclusive control by the user of the functional resource, wherein the placeholder resource is associated with the functional resource such that the placeholder resource is a placeholder for at least one other user waiting to acquire control of the functional resource.

8. A method as claimed in claim 7, wherein the functional resource is released by the user of the functional resource if the placeholder resource is found to be unavailable.

9. A method as claimed in claim 8, further comprising acquiring control of the functional resource by the at least one other user and releasing control of the placeholder resource by the at least one other user after the functional resource is released by the user.

10. A software environment that provides the capability for a first user to determine if any other user is waiting to acquire control of a functional resource, comprising:
A placeholder resource that is associated with the functional resource;
Executable code that provides for the acquisition of control of the placeholder resource by said any other user; and
Executable code that indicates to the first user whether the placeholder resource is available.

11. A software environment as claimed in claim 10, wherein the placeholder resource is non-functional.

12. A data processing system, comprising:
at least one processor;
a bus coupled to the at least one processor;
at least one computer usable medium coupled to the bus, wherein the at least one computer usable medium contains a functional resource and a placeholder resource associated with the functional resource, wherein the at least one computer usable medium contains:
a first set of instructions that are executable by the at least one processor for acquiring control of the placeholder resource by a user waiting to acquire control of the functional resource; and
a second set of instructions that are executable by the at least one processor for indicating to another user whether the placeholder resource is available for exclusive control to the other user.

13. A data processing system, as claimed in claim 12, wherein the data processing system further includes a third set of instructions that are executable by the at least one processor for releasing the functional resource by the other user if the placeholder resource is unavailable for exclusive control to the other user.

14. A computer program product for use in a software environment including a functional resource and a placeholder resource that is associated with the functional resource and that serves as a placeholder for a user waiting to acquire control of the functional resource, wherein the computer program product comprises at least one computer usable medium including:
computer-usable program code for acquiring control of the placeholder resource by a user waiting to acquire control of the functional resource; and
computer-usable program for indicating to another user whether the placeholder resource is available for exclusive control to the other user.

15. A computer program product as claimed in claim 14, wherein the second instance of the application is started after the first instance of the application is shut down completely.
